(19) United States
(12) Patent Application Publication
(10) Pub. No.: US 2008/0208668 A1
(43) Pub. Date: Aug. 28, 2008

(54) METHOD AND APPARATUS FOR DYNAMICALLY ALLOCATING MONETIZATION RIGHTS AND ACCESS AND OPTIMIZING THE VALUE OF DIGITAL CONTENT

(76) Inventors: Jonathan HELLER, San Francisco, CA (US); Jingchun (Diane) Yu, Palo Alto, CA (US); Michael Henry Evangelista, Metuchen, NJ (US)

Correspondence Address: GLENN PATENT GROUP, 3475 EDISON WAY, SUITE L, MENLO PARK, CA, 94025, US

(21) Appl. No.: 11/966,893

(22) Filed: Dec. 28, 2007

Related U.S. Application Data
(60) Provisional application No. 60/891,530, filed on Feb. 26, 2007.

(51) Int. Cl. G06F 17/40

(52) U.S. Cl. 705/8

(57) ABSTRACT

A method and apparatus dynamically allocates monetization access and optimizes the value of digital content by managing the access rights and monetization rights, delivery, measurement and by accounting for advertising, promotion and digital messaging within, over, and around digital content across a distributed network of business entities and a distributed network of delivery platforms.

### BACKGROUND OF THE INVENTION

1. Technical Field

The invention relates to digital content. More particularly, the invention relates to a method and apparatus for dynamically allocating monetization access and optimizing the value of digital content.

2. Description of the Prior Art

With forms of digital content, such as video, the asset that might attract an audience does not attract the maximum size audience from a single consumer access point but from many different access points. These access points may be different business entities. Therefore, to maximize the consumption of such a content asset, such as a video, an episode of a television show, or a movie, it is necessary to enable access to that content asset from many points.

This effect is demonstrated, as an example, in the retail industry by content owners putting copies of their product up for sale in as many retail locations as possible. This is convenient for consumers, especially with items that are purchased on impulse, and allows the content owner to reach the largest possible pool of consumers. With retail sale or rental of a content asset, this works fine, because each unit sold is one more unit sold that results in incremental revenue and profit.

This does not work when the content is monetized by advertising because this breaks the audience up into fragmented components in each of the access points. Advertisers, the buyers of ad supported media, need to reach single large blocks of consumers with their message easily. When the audience fragments into small pieces, it materially reduces the value of the content because it vastly increases the cost and effort of placing a message in front of a large group of consumers.

Traditionally, in offline media, this was not an issue because there was only a single or dominant access point through which consumers might consumer any particular piece of ad supported content, for example:
The local cable company; or
The network, broadcast affiliate, or cable programming channel.

While there may be numerous of these access points situated at a plurality of geographic locations, within each geographic location particular pieces of content are only accessible through a single or dominant access point. So, there is no audience fragmentation within a particular geography. Therefore, re-aggregating the audience is simply a question of adding up the geographic locations or sending the same message to all geographic location.

Critically, the re-aggregation of this audience, the right to access the ad/message inventory for monetization, and control over the consumption and monetization of that audience is centrally held by the content rights owner. This is a key point. The content rights owner needs;

1. A large scale audience that is big enough to interest advertisers;
2. The ability to manage and deliver the advertisers messages and their own promotional messages to this large enough audience reasonably; and
3. Control of this entire process, the resultant monetization of the audience, and the relationship/interaction with the advertisers.

With traditional media, such as broadcast or cable television, the content rights owners have all three of these abilities because they decide what ad/message goes into the content before it gets distributed to the various access points. The content rights owners do share some of the ad/message inventory with the various access point/distributors in a discrete and inflexible manner that is infrequently set by lengthy negotiation and, once set, very difficult to change. With this negotiated division of inventory, it is impossible to optimize the revenue yield and value of the ad inventory by dynamically choosing the highest yield ad each time an opportunity arises. With the negotiated division of inventory, advertising demand cannot cross the negotiated lines. Therefore, while this traditional television/syndication method does enable the content rights owner to have the audience scale, access rights, and monetization control that they need, its very inflexibility greatly under values the available inventory.

It is impossible for the highest paying advertiser to access all the ad/message inventory it may desire if doing so crosses the inflexible divisions of inventory that exist in the traditional television arrangements. This inventory illiquidity is a key problem of traditional syndication and ‘tv content deal’ method that greatly undermines the optimal value of the audience generated by the content assets.

Lastly, the access point/distributor business entities also want control over their revenues and advertiser relationships which this negotiated allocation of inventory does not support. It creates a zero sum game negotiation effect because the various parties only get compensated when they sell ads, even though they are all contributing different values, such as the creation of appealing content (content rights owners) or the origination of instances of consumption of that content (access point/distributors). This zero sum effect creates very sub-optimal allocations of inventory for ad monetization and constrains consumer broad access to all forms of desired content.

With the advent of the Internet as a distribution/access point, an additional series of problems have evolved. Firstly, with content such as video, audio, and other entertainment products, the individual content asset is the attraction, not the company that owns or produces all the individual content pieces. Therefore, consumer attention has fragmented to numerous providers of aggregation and search/discovery of content, as well as directly to the content rights owners themselves. So, unlike the traditional television business, this exacerbates the problem of generating the maximum coherent audience for content.

It is vastly sub-optimal to put any particular content asset in a single access location, such as only on the website of the content rights owner, because this reduces the number of consumers who access it. This greatly reduces the content asset's value as both a product for retail sale and especially as an audience vehicle to monetize through advertising or promotion. However, if content is placed in many of these aggregator/distribution points, then this creates the fragmentation problem described above, which vastly reduces the advertising value of any such content asset.

Currently, these issues are sub-optimally handled by one of two methods. Either the content rights owner licenses rights to the content to the aggregator/distributor and receives some form of payment. Or, the content rights owner syndicates their content to the aggregator/distributors and, as in the traditional television model, maintains the access and monetization rights to the content and the control of the ad/message inventory.

Both of these methods are insufficient and sub-optimal for at least three reasons.

1. They both suffer from the inflexible ad/message inventory problem of the traditional television syndication methods. One cannot yield optimize across the negotiated ad/message inventory allocations.
2. They both suffer from the ‘control and zero sum negotiation’ problem of the television/syndication method. One or the other of the parties involved cedes the control they do not want to cede of the management of the ad/message inventory and the advertiser sales and relationship management. On the Internet, both the content rights owners and the aggregator/distributors are media companies. This is particularly true for the content rights owners of professionally produced content.

Therefore, both want and need both large scale audience and the control of the ad/message inventory and advertiser relationships.
The content rights owners own rights to libraries of content that they both sell and monetize through advertising and package and sell such advertising to marketers.
The aggregator/distributors aggregate and distribute content from many such content rights owners which they both sell and monetize through advertising.
Lastly, the business lines are blurry and porous between these two parties where both create or own the rights to content and aggregate others' content.
   3. The existing methods of addressing this situation are inflexible and it is very difficult to alter the division of control and allocation of revenues to different business situations flexibly, and to do so dynamically to maximize total yield generated from the consumption of a content asset.

Therefore, these three issues of sub-optimal ad/message inventory yield optimization and flexible control of access rights and monetization rights to the content assets have created something of a blockage slowing the growth of internet video monetization. Content rights companies fight aggregator/distributors over copyright violations yet do not license or syndicate content to these very parties that would vastly increase the size and value of their audiences because of the constraints above.

### SUMMARY OF THE INVENTION

The invention provides a method and apparatus for dynamically allocating monetization rights and access and optimizing the value of digital content by managing the access rights and monetization rights, delivery, measurement and accounting for advertising, promotion and digital messaging within, over, and around digital content across a distributed network of business entities and a distributed network of delivery platforms.

### BRIEF DESCRIPTION OF THE DRAWINGS

FIG. 1 is a logical flow diagram showing the process of determining which business entity gets access to show an ad/message in any available ad/message slots upon the origination of an instance of consumption of a content asset according to the invention; and

FIG. 2 is a visual representation of a dynamically determined potential virtual network across multiple content assets and business entities according to the invention.

### DETAILED DESCRIPTION OF THE INVENTION

The apparatus and method described herein solves both the problems of flexible control of access and monetization rights to the ad/message inventory of content assets, as well as the yield optimization of the inventory across all related parties. It dynamically allocates the access rights to a unit of ad/message inventory within a content asset, as well as separately determining the monetization rights to compensate parties for both the creation of the content, as well as the origination of a consumer's consumption of that content asset, to all the relevant parties with each and every instance of a consumer accessing a content asset. These two dynamic allocations are centered on the content asset, the ad/message slot associated with the content asset, and which business entity, in that specific instance, contributed what value to the monetization of that content asset.

The allocations, i.e. access and compensation, are separately and dynamically determined based on who contributed what value to the monetization of that asset and how the business entities in question negotiated who gets what access control and monetization compensation in which circumstances. While the same content asset might be available for consumption on multiple aggregator/distributors, as well as on the website of the content rights owner themselves, the actual allocation of access rights to place ad/messages into, over, or around the content asset being consumed can be granted only to that entity that actually originated the view or instance of consumption of that content, to the entity that owns the rights to the content, or in any combination desired. Separately, monetization compensation for value generated is determined and allocated based on who did what in that instance. In this way, the content rights owner can distribute content assets across numerous aggregator/distributors and retain all access rights to monetize the inventory, creating sufficient scale for advertisers, while compensating the aggregator/distributors for having originated the view of that content asset. Key to the invention is the flexibility inherent in separating the access rights determination from the monetization rights determination, and doing both dynamically.

Based on where a view or instance of consumption of a content asset originated, who owns the rights to the content, and who sold the advertising that monetized the content, any combination of compensation and control rights can be supported. Because the thorniest issues amongst business entities have historically concerned power struggles around both compensation and control, the ability to enable a flexible arrangement of either compensation and control, based on who actually did what to contribute is unique, unobvious, and powerful. The invention thus provides a technique that lets the various parties flexibly divide and share the value created when a content asset is consumed, and that compensates the parties for the value created.

In the presently preferred embodiment of the invention, ad/message inventory associated with a content asset can be shared by allocating different ad units associated with a content asset or proportions of the same ad units associated with a piece of content. This is termed ‘access rights’ herein.

The party who owns the rights to the content gets compensated for its' rights and the party that originated the instance of a consumer consuming the content gets compensated for creating that opportunity. If applicable, any third party that actually sold the ad/message opportunity to an advertiser also gets compensated for having generated that sale. This is termed ‘monetization rights’ herein.

Additionally, the access to any ad/message slot in any content asset can be set to choose amongst many different business entities' advertiser campaigns dynamically to ensure the maximum yield for every instance of the content being consumed by having the most advertiser campaigns compete to win the right to show their ad/message. This yield optimization can be enacted for any ad/message unit on any content asset being accessed from any point and limited to be enabled only when certain floor price or other limiting conditions are met. This is termed ‘contingent access rights’ herein.

A fundamentally unique and differentiated aspect of the invention is the fact that access rights, monetization rights, and contingent access rights to any ad/message unit in any content asset are dynamically determined each time a content asset is consumed, based on the combination of:
Who originated a viewing of a video, or consumption of an instance of a content asset;
Who owns the rights to that content asset; and
Who sold the advertisement that ran in the ad/message slot.

Traditional online media networks and ad management systems determine access rights and monetization rights based on fixed hierarchical organizations of media sales entities that sell ad supported content organized in content hierarchies, such as automotive, technology, travel, etc. and pay the owners of that content a fee for access rights to monetize their content. This traditional Web network method, as with the traditional television syndication method, cedes control of access and monetization of the ad/message inventory, and the resultant advertiser relationship, to the media sales entity. Traditionally on the Web, this arrangement is based on a fixed, negotiated infrequently, allocation of such rights to a media sales entity. Also, if one deploys this traditional Web method with numerous media sales entities such as ad networks, one creates the audience fragmentation and sub-optimal inventory yield optimization problems described above.

Additionally, the traditional web ad network representation models rely on the content rights owners to produce both the content and the audience viewing it. As stated above, this works when, as with websites, the audience comes to the single access point, i.e. the site itself. This falls apart when the audience accesses the content from many aggregator/distributor access points on a content asset by content asset basis, i.e. with video content assets. With content, such as video, where the individual content asset is what attracts the consumer, not the website of the content rights owner, content rights owners need to distribute content assets to many aggregator/distributors to build audience critical mass. Driving consumers to a single access point destination, as with traditional Web publishing, has proven to produce insufficient audience of content assets. In traditional content retail, this is why DVDs are stocked in as many retail locations as possible across many retail business entities.

When advertising is a key monetization method, this creates fragmentation of audience. However, unlike with traditional ad network approaches, Content rights owners, or their sales representation partners, must re-aggregate the audience on a content asset basis, not on a content rights owner basis, as traditional media sales ad network/publisher models are organized.

### EXAMPLE

A traditional ad network or ad management system aggregates a viewings of www.nbc.com or www.cnn.com/finance.
A video or other individual-content-asset-as-attraction model must re-aggregate content by the nature of the content asset itself, not by the name of it's content rights owner, as with all viewings of ‘The Office’ not all viewings of NBC shows.

Thus, a critical unique factor is the organization of the aggregation of ad/message inventory by the content asset, not by the content rights owner. The apparatus and method disclosed herein makes the content asset the hub of aggregation of audience. Appending any additional taxonomy or ownership information to the content asset enables any other more traditional aggregation as well.

The content asset may be distributed across numerous aggregator/distributors and its advertising/message inventory sold through numerous media sales entities. Therefore, the access rights to put a message into an ad/message slot, the contingent access rights to optimize yield, and the monetization rights of who gets compensated how for each piece of the value chain created, are all dynamically decided at the moment a consumer accesses an instance of a content asset, to allocate both access control and compensation to the business entities involved flexibly and with an optimal yield. This supports the level of flexibility in business control arrangements and compensation for value created needed to manage in such a distributed business environment, while maintaining the necessary ability to aggregate the audiences back up into large enough blocks to interest advertisers. These dynamic distributed aggregations of content asset ad/message inventory are termed ‘virtual networks’ herein.

The apparatus and method herein disclosed solves the following problems inherent in maximizing the value of a library of content assets across a distributed set of access points:

1. Maximum access to consumers is enabled by enabling distribution across as many access points as desired.
2. Re-aggregation of audience is enabled, content asset by content asset or any appropriate taxonomy roll up, across the distributed access points.
3. Content rights owners maintain any level of desired access and monetization rights control they choose.
4. Aggregator/distributors get access to the broadest selection of content assets possible, thus increasing their appeal to consumers.
5. Aggregator/distributors get paid appropriately for either generating a view of a video or instance of consumption of a content asset.
6. Aggregator/distributors, which are also media sales companies can negotiate for, or compete for, access rights, enabling them to have the level of control they also desire over the audience they build and the advertiser relationships they build, and this is possible across numerous content rights owners.
7. Ad/message inventory on any content asset can be yield optimized by ensuring as much different advertiser demand from as many sources as enabled can compete to produce the best value for the audience.
8. Such contingent access rights can be limited by whatever hurdle price and other target constraints the content rights owner chooses, such as ‘only if the ad is targeted in a user geography outside the US.

All in, the apparatus and method herein disclosed enables an environment tailored for the evolving world of online video and content asset consumption that solves the needs of the various parties involved, thus unblocking the constraints that limit the distribution of professional content online. It does so in a way that is both unique and unobvious because all the previous existing methods were developed around the technical constraints of broadcast television that did not allow for dynamic yield optimization of ad inventory across access rights owners, or the traditional hierarchical Web-based model where the content rights owner is the audience attraction entity.

With the advent of numerous online and IP television based aggregator/distributors, and the fact that the individual content asset, as with the television show itself, is the audience attraction entity, not the access point of the content rights owner, the herein disclosed content asset centric, dynamic access rights and monetization rights system across a distributed network of aggregator/distributors is needed and unique.

The inventive apparatus and method is based on the core concept that the individual content asset, such as an episode of a television show or a movie, is the central organizing item of the system, and not the content rights owner or publisher as the central organizing item, as is done in traditional online ad management systems. Access to ad/message inventory and compensation for the values created of owning rights to the content asset, originating the view or consumption of the content and selling ads into the content are all determined dynamically when a content asset is viewed or consumed. The access and monetization rights are stored in a central database tied to the content asset. When a view or instance of consumption of a content asset occurs, access rights and monetization rights, i.e. compensations due, are dynamically and separately determined based on the intersection of which business entity originated the view of the content asset, owned the content rights to the content asset, sold the advertising that monetized the content asset. By making the specific content asset the central organizing item, access and compensation for different value contributions can be dynamically set based on whichever combination of values where actually contributed by whichever business entities contributed them. This creates the needed flexibility to manage monetization of content assets in a highly distributed business entity environment, where numerous parties add different pieces to the total value created. Also, given the need to support numerous negotiated forms of who gets what access and what compensation, this complete flexibility is required.

Hierarchical traditional ad management systems, organized around the publisher, website and page can not support this additionally complex distributed business environment flexibly enough. Audience views or consumptions of that content asset could originate from many different access points controlled by many different business entities. A business entity has a virtual network of potential ad/message inventory across a library of content assets for which they either are granted pre-determined access rights to an ad/message slot of a particular content asset by the content rights owner, or are granted contingent access rights to an ad/message slot of a particular content asset and could compete to win the opportunity to show an ad/message with all other business entities possessing contingent access rights to that ad/message slot of that content asset.

Monetization rights and associated compensation are allocated based on value contributions, such as:

1. Which business entity originated the view or consumption of the content asset;
2. Which business entity owns the content rights to that content asset; and
3. Which business entity sold the advertiser or marketer who paid to run an ad/message in an available slot in, over, or around that content asset.

Monetization rights and associated compensation for all three value contributions could all be from a single entity that owned the content rights, originated the view and sold the advertiser, or any combination of the three across multiple business entities. Actual allocations are determined by business arrangement and stored in the system. This gives the content rights owner complete flexibility of how to maximize consumption of the content and maximize value of their content, all while maintaining any desired level of control and all in a form that also allows the other value contributors to be compensated for whichever part of the value they contributed, such as a view origination or an advertising sale. This uniquely solves the problems outlined above. This asset centered dynamic ad/message inventory allocation and monetization attribution is optimal for a business environment, where there are many different content assets that attract consumes, many points of access that drive consumption of these content assets, many content rights owners, and many sales channels that bring advertiser demand to monetize the content assets.

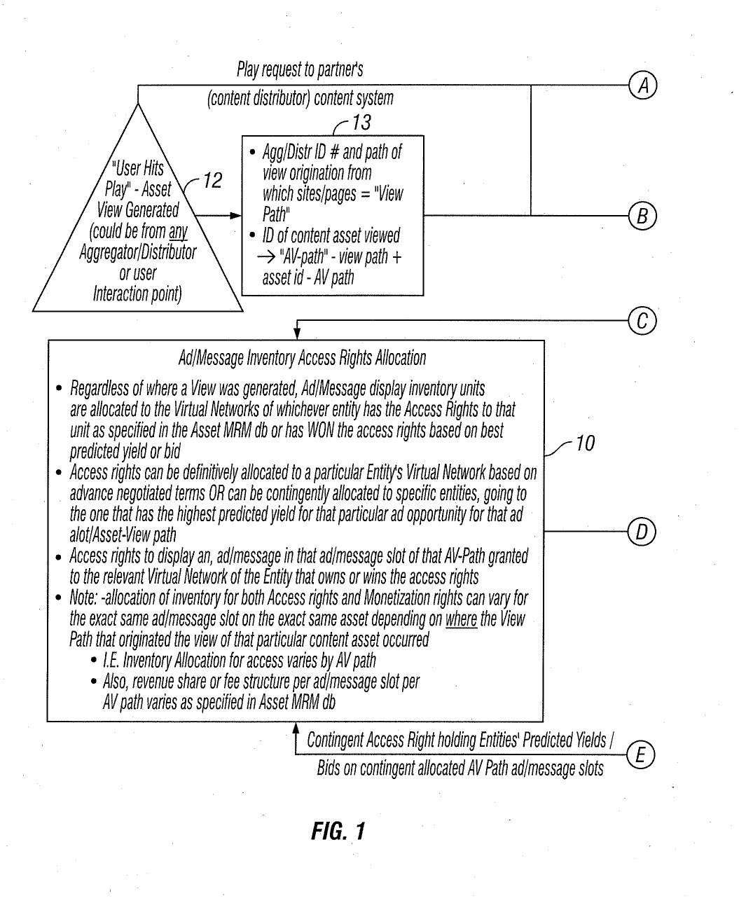

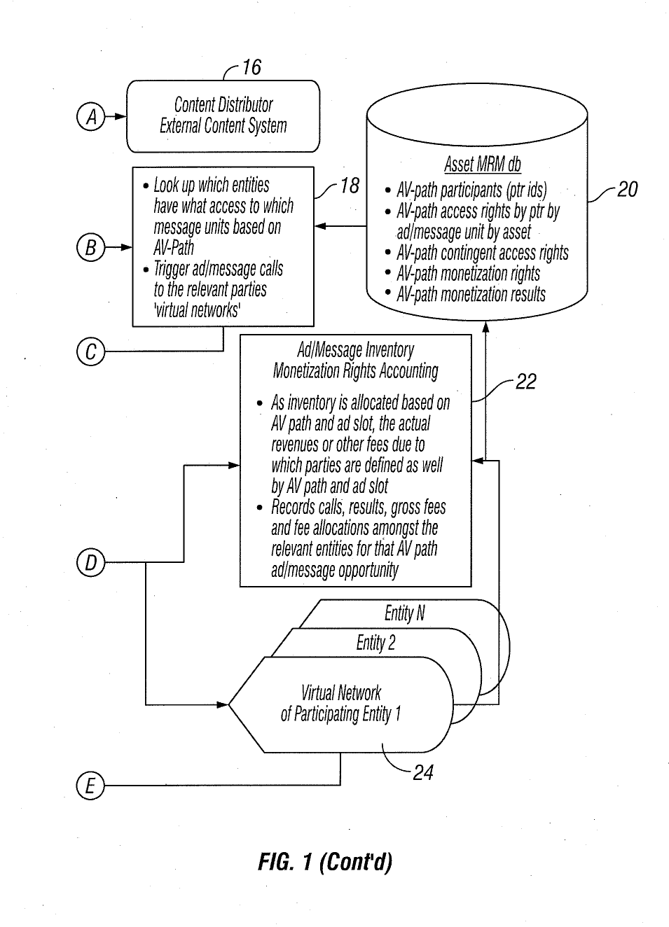

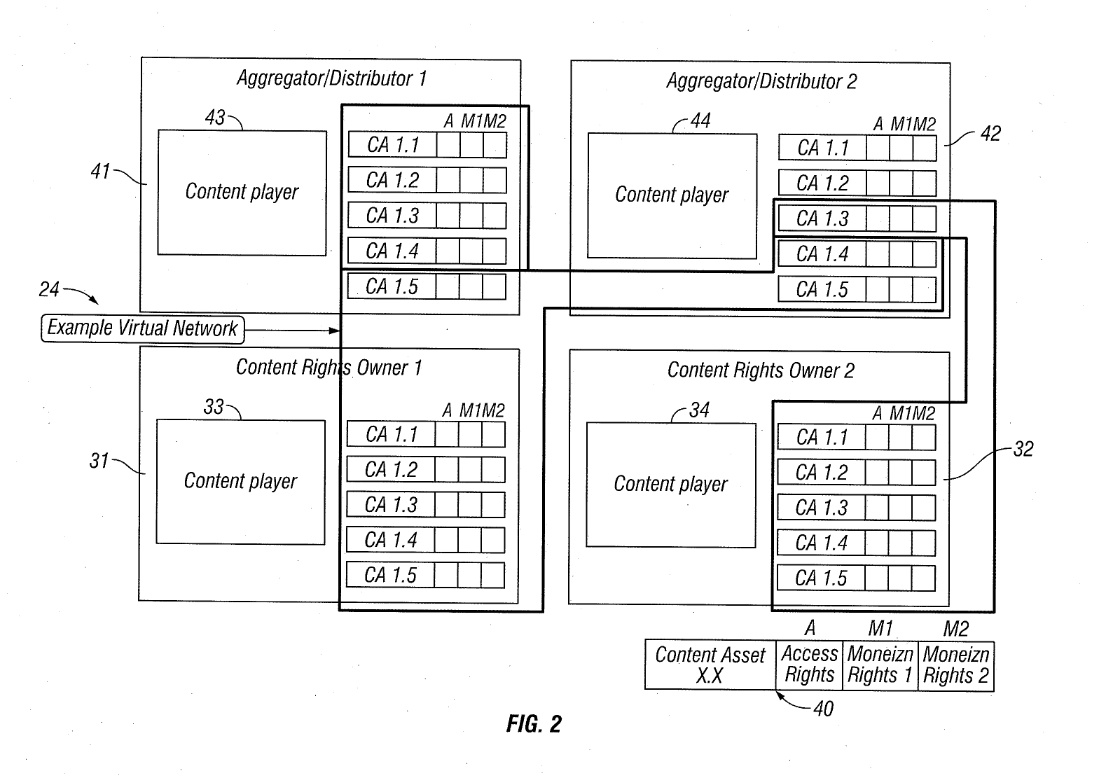

FIG. 1 is a logical flow diagram showing the process of determining which business entity gets access to show an ad/message in any available ad/message slots upon the origination of an instance of consumption of a content asset according to the invention. In FIG. 1, the central element is an ad/message inventory access rights allocation module 10. With regard to the module 10, ad/message inventory display inventory units are allocated to virtual networks 24 (see, also FIG. 2) of whichever entity has access rights to that unit, as specified in the asset MRM database 20, or that has won the access rights, based upon best predicted yield or bid, regardless of where a view was generated. Access rights can be definitively allocated to the particular entity's virtual network based upon advance negotiated terms or they can be contingently allocated to specific entities, going to the entity that has the highest predicted yield for a particular ad opportunity for a particular ad slot, asset-view path. Access rights to display an ad/message in that ad/message slot of that asset-view path are granted to the relevant virtual network of the entity that owns or wins the access rights. Note that allocation of inventory for both access rights and monetization rights can vary for the exact same ad/message slot on the exact same asset, depending upon where the view path that originated the view of that particular content asset occurred. That is, inventory allocation for access varies by asset-view path. Also, revenue share or fee structure per ad/message slot per asset-view path varies, as specified in the asset MRM database.

The ad/message inventory access rights allocation module 10 receives the predicted yields and bids on contingent allocated asset-view path ad/message slots of an entity holding contingent access rights from corresponding virtual networks of participating entities 1-N 24. The virtual networks also interact with an ad/message inventory monetization rights accounting module 22. In the module 22, the actual revenues or other fees due to which parties are defined by asset-view path and ads slot as inventory is allocated based upon asset-view path and ad slot. The module 22 records calls, results, gross fees, and fee allocations amongst the relevant entities for each particular asset-view path opportunity. The module 22 is coupled to receive information regarding ad/message inventory access rights allocation from the ad/message inventory access rights allocation module 10. An output of the module 22 provides information to the asset MRM database 20.

The ad/message inventory access rights allocation module 10 also receives inputs based upon the following:

When a module 12 detects the a user hits a “play” button, for example, an asset view is generated. This could be from any aggregator or distributor or any user interaction point.

A play request is routed to a partner's, e.g. content distributor's, content system 16.

The asset view generated 13 includes an aggregator or distributor ID number and path of view origination from which sites or pages=“View Path.” The ID of the asset viewed is the AV-path, which is equivalent to the view path+asset id. This information is provided to a further module 18 that looks up which entities have what access to which message units based upon the asset-view path. The module 18 communicates with the ad/message inventory access rights allocation module 10 to trigger ad/message calls to the relevant parties virtual networks.

The module 18 also receives the following information from the asset MRM database 20: asset-view path participants partner IDs, asset-view path access rights by partner by ad/message unit by asset, asset-view path contingent access rights, asset-view path monetization rights, and asset-view path monetization results.

FIG. 2 is a visual representation of a dynamically determined potential virtual network across multiple content assets and business entities according to the invention. FIG. 2 shows a few possible examples of a virtual network. There are many possible permutations of what constitutes a virtual network, all of which are within the scope of the invention. This depends upon what asset rights are set, how content assets are distributed, and where or view or instance of consumption of a content asset originates.

In FIG. 2, a virtual network 24 (see, also, FIG. 1) comprises a plurality of content rights owners 31, 32 and a plurality of aggregators and/or distributors 41, 42. For purposes of the invention, there is no set number of content rights owners and aggregators and/or distributors that constitute a virtual network. Each content rights owner in this embodiment includes a respective content player 33, 34. Likewise, each aggregator and/or distributor in this embodiment includes a respective content player 43, 44.

For a particular content asset X.X 40, the invention considers access rights A, a first set of monetization rights M1, and a second set of monetization rights M2. Other sets of rights may be considered in other embodiments of the invention.

Content rights owner 1 (31) owns content assets CA 1.1, CA 1.2, CA 1.3, CA 1.4, and CA 1.5. Content rights owner 2 (32) owns content assets CA 2.1, CA 2.2, CA 2.3, CA 2.4, and CA 2.5. In the example of FIG. 2, the various rights A, M1, and M2 between the participants in the virtual network are shown for each participant in a table, where the rights are table cells are shaded to indicate such rights.

### Exemplary Architecture

The following summarizes an exemplary architecture of the invention, as described above in connection with FIGS. 1 and 2:

The invention comprises a module for centrally assigning an ID and managing the ID of any aggregator/distributor, for example through a central access and monetization rights management database system containing the ID and ID management of any participating aggregator/distributor. The invention also comprises a module for centrally assigning an ID and managing the ID of any content rights owner, for example through the central access and monetization rights management database system, which contains the ID and ID management of any participating content rights owner.

The invention also comprises a module for centrally identifying each particular content asset and centrally managing the IDs of each content asset, for example through the central access and monetization rights management database system, which contains the content asset ID and ID management of any particular content asset. A related method for assigning each content asset to a content rights owner and managing this assignment also includes a module for managing any sub-rights holders or other tracking of related parties with whom the content rights owner has relationships around owning the rights to any content. Note that this technique allows for content assets to change hands between different content rights owners as those rights change over time.

The invention also comprises a related module for assigning any descriptive elements or meta descriptive element types to any particular content asset. A related module may be provided for assigning any desired organization taxonomy to any content asset.

A further component of the invention comprises a module for identifying, assigning, and managing whichever desired ad/message slots should apply to any particular content asset, and creating and managing the resultant ad/message slot IDs. The combination of the ad/message slot ID and the content/asset ID creates the ad/message slot IDs for that particular content asset.

A further component of the invention may comprise a module for centrally assigning an ID and managing the ID of any ad/message slot sales channel. This can be accomplished through the central access and monetization rights management database system, which contains the ID and ID management of any participating ad/message slot sales channel. A related technique may be used for assigning and managing the IDs and permissions of any sales person or other system functionary within such an ad/message sales channel.

A further component of the invention comprises a module for assigning and managing the access rights and monetization rights to any ad/message slot associated with any content asset. A related module may be provided for defining access right types, for example defining types of access rights including, but not limited to, 100% access, proportional shared access, and access to a fixed number of ad/message slot per content asset per duration of time. This aspect of the invention may also include a module for defining and adding new access right types over time or modifying existing access right types. Assignment of such rights can be such that any particular access right type can only apply to the particular ad/message slot of any particular content asset.

A related embodiment is concerned with a module for defining the conditions under which granting of such access rights occurs. These conditions include but are not limited to;

1. Only when the relevant party, such as an aggregator/distributor, originated the view or consumption of the content asset; and
2. The creation of a sequential access order and allowing access only if there is no other existing ad/messages from any of the higher prioritized entities that have access rights.

Another embodiment of the invention comprises a technique for defining any particular ad/message slot, either in total or associated with any particular content asset or any grouping of content assets, as contingently accessible. A related embodiment provides a module for defining the conditions under which contingent access rights are granted. These conditions can include, but are not limited to, minimum revenue potential per ad/message, geographic or time of day restrictions or any other enabled method of identifying and targeting any ad/message slot.

A further embodiment of the invention provides an apparatus and method for assigning actual access rights to any participating entity for any particular ad/message slot in, over or around any particular content asset. A related embodiment comprises a module for assigning monetization rights and compensation rules to all enabled parties for any particular ad/message slot for any particular content asset.

A further related embodiment comprises a module for defining monetization right types and compensation rules, including but limited to:
Proportional advertising revenue share; proportional advertising profit share; fixed cost per instance of content consumption; fixed cost for a fixed number of instances of content consumption; and fixed cost for an unlimited number of instances of content consumption.

This embodiment also includes an apparatus and method for defining and adding new monetization right types over time, or modifying existing monetization right types. This assignment can be such that any particular monetization right type can only apply to the particular ad/message slot of any particular content asset.

A related embodiment comprises a module for assigning actual monetization rights and compensation rules to any participating entity for any particular ad/message slot in, over, or around any particular content asset.

A further embodiment of the invention provides an apparatus and method for transmitting the fact that a view has been initiated for a particular content asset, and the identity of that aggregator/distributor or other view originator of that content asset, to the asset and monetization rights management system upon each origination of a view or instance of consumption of any particular content asset. This can be accomplished through any number of the standard data transmission methods currently in use on the internet such as, but not limited to, an http:// call as is often used in current ad management systems.

A further embodiment of the invention provides a module for allocating the actual access to any particular ad/message slot in any particular content asset based on the rules in the asset and monetization rights management system above.

A further embodiment of the invention provides a module for recording and storing the actual effects and results of displaying or delivering the content asset and related ad/messages.

A further embodiment of the invention provides a module for calculating and accounting for the compensation due to all relevant parties based on the monetization rights as recorded in the asset and monetization rights management system above.

A further embodiment of the invention provides a module for calculating and yield optimizing which business entity wins access rights for any ad/message slot that has contingent access rights.

The invention also comprises an apparatus and method for tracking, logging, and reporting on the metrics and results including, but not limited to, the following:
Content asset usage by asset-view path of which business entity originated the view, by any entity that owns any form of access or monetization rights, and by any taxonomy or organization enabled in the content asset management method and apparatus described above;
Content value and revenue generation accounting and reporting by asset-view path of which business entity originated the view, by any entity that owns any form of access or monetization rights, and by any taxonomy or organization enabled in the content asset management method and apparatus described above; and
Permissions, rights management, and contracts.

A further embodiment of the invention provides an apparatus and method for defining and managing the ad/message slot virtual networks of any participating business entity that has potential access rights including, but not limited to:
Content asset library management and related ad/message slot management;
Taxonomy and various grouping and organizational management of content assets and ad/message slots as desired to package for media sales such as, e.g. ad/message slot media buy sales process and order management, and ad/message best candidate message selection, yield optimization, ad/message slot message serving and reporting.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for controlling access and monetization rights to an ad/message inventory of content assets, comprising the steps of:
dynamically allocating access rights to a unit of ad/message inventory within a content asset; and
separately dynamically determining monetization rights to compensate parties for both creation of said content and origination of a consumer's consumption of said content asset, for all relevant parties with each and every instance of a consumer accessing a content asset;
wherein said dynamic allocation and determination of rights is centered on said content asset, an ad/message slot associated with said content asset, and a business entity in each specific instance that contributed what value to monetization of said content asset.

2. The method of claim 1, further comprising the step of:
separately and dynamically determining access and monetization based on who contributed what value to the monetization of a particular asset and how business entities in question negotiated who gets what access control and monetization compensation in which circumstances.

3. The method of claim 1, further comprising the step of:
granting actual allocation of access rights to place ad/messages into, over, or around a content asset being consumed to an entity that actually originated a view or instance of consumption of said content asset, to an entity that owns rights to said content asset, to an entity engaged to sell ads on behalf of a rights owner of said content asset, to a distributor of said content asset, or in any combination thereof.

4. The method of claim 1, further comprising the step of:
determining and allocating monetization compensation for value generated based on who did what in that instance;
wherein a content rights owner can distribute content assets across numerous aggregator/distributors and retain all access rights to monetize an inventory, creating sufficient scale for advertisers, while compensating said aggregator/distributors for having originated a view of a content asset.

5. The method of claim 1, further comprising the step of:
sharing ad/message inventory associated with a content asset by allocating different ad units associated with a content asset or proportions of the same ad units associated with a piece of content

6. The method of claim 1, further comprising the steps of:
compensating a granting party who owns rights to a content asset for its' rights; and
compensating a party that originated an instance of a consumer consuming said content asset for creating that opportunity.

7. The method of claim 1, further comprising the step of:
establishing contingent access rights to any ad/message slot in any content asset to choose amongst many different business entities' advertiser campaigns dynamically to ensure maximum yield for every instance of said content asset being consumed;
wherein advertiser campaigns compete to win a right to show an ad/message.

8. The method of claim 1, further comprising the step of:
dynamically determining access rights, monetization rights, and contingent access rights to any ad/message unit in any content asset each time a content asset is consumed, based on the combination of:
who originated a viewing of a video, or consumption of an instance of a content asset;
who owns rights to a content asset; and
who sold an advertisement that ran in an ad/message slot.

9. The method of claim 1, further comprising the step of establishing a virtual network by:
distributing content assets across a plurality of aggregator/distributors; and
selling advertising/message inventory through a plurality of media sales entities;
wherein access rights to put a message into an ad/message slot, contingent access rights to optimize yield, and monetization rights of who gets compensated how for each piece of a value chain created, are all dynamically decided at the moment a consumer accesses an instance of a content asset; and
wherein both access control and compensation are flexibly allocated to business entities involved with an optimal yield.

10. An apparatus for providing content asset centric, dynamic access rights and monetization rights across a distributed network of aggregator/distributors, comprising:
a plurality of individual content assets, each having a content rights owner or publisher;
a central access and monetization rights database tied to each content asset for storing access and monetization rights of each content asset; and
means for dynamically determining access to ad/message inventory and for separately, dynamically determining compensation due (monetization rights) for values created of owning rights to a particular content asset, originating a view or consumption of said content asset, and selling ads into said content asset when said content asset is viewed or consumed;
wherein access rights and compensations due are dynamically and separately determined when a view or instance of consumption of a content asset occurs, based on an intersection of which business entity originated said view of said content asset, owned content rights to said content asset, and/or sold advertising that monetized said content asset; and
wherein access and compensation for different value contributions are dynamically set based on whichever combination of values where actually contributed by whichever business entities contributed them.

11. The apparatus of claim 10, further comprising:
a virtual network of potential ad/message inventory across a library of content assets for which one or more business entities either are granted pre-determined access rights to an ad/message slot of a particular content asset by a content rights owner, or are granted contingent access rights to an ad/message slot of a particular content asset and could compete with all other business entities possessing contingent access rights to that ad/message slot of said content asset to win an opportunity to show said ad/message.

12. The apparatus of claim 10, said means for dynamically determining compensation due comprising:
means for determining how monetization rights and associated compensation are allocated based on value contributions comprising any of:
which business entity originated a view or consumption of a content asset;
which business entity owns content rights to a particular content asset; and
which business entity sold an advertiser or marketer who paid to run an ad/message in an available slot in, over, or around a particular content asset;
wherein all three value contributions are from a single entity that owned said content rights, originated a view and sold an advertiser, or any combination of the three across multiple business entities; and
wherein actual allocations are determined by business arrangement and stored in said database.

13. A method for providing content asset centric, dynamic access rights and monetization rights across a distributed network of aggregator/distributors, comprising the steps of:
providing a plurality of individual content assets, each having a content rights owner or publisher;
providing a central access and monetization rights database tied to each content asset for storing access and monetization rights of each content asset; and
dynamically determining access to ad/message inventory and for separately, dynamically determining compensation due (monetization rights) for values created of owning rights to a particular content asset, originating a view or consumption of said content asset, and selling ads into said content asset when said content asset is viewed or consumed;
wherein access rights and compensations due are dynamically and separately determined when a view, or instance of consumption of a content asset occurs, based on an intersection of which business entity originated said view of said content asset, owned content rights to said content asset, and/or sold advertising that monetized said content asset; and
wherein access and compensation for different value contributions are dynamically set based on whichever combination of values where actually contributed by whichever business entities contributed them.

14. The method of claim 13, further comprising the step of:
centrally assigning an ID and managing an ID of any aggregator/distributor through said central access and monetization rights management database.

15. The method of claim 13, further comprising the step of:
centrally assigning an ID and managing an ID of any content rights owner through said central access and monetization rights management database.

16. The method of claim 13, further comprising the step of:
centrally identifying each particular content asset and centrally managing an ID of each content asset, through said central access and monetization rights management database.

17. The method of claim 13, further comprising the steps of:
assigning each content asset to a content rights owner and managing this assignment; and
managing any sub-rights holders or other tracking of related parties with whom a content rights owner has relationships around owning rights to any content asset.

18. The method of claim 13, further comprising the step of:
assigning descriptive elements or meta descriptive element types to any particular content asset.

19. The method of claim 13, further comprising the step of:
assigning a desired organization taxonomy to any content asset.

20. The method of claim 13, further comprising the steps of:
identifying, assigning, and managing which ad/message slots should apply to any particular content asset; and
creating and managing resultant ad/message slot IDs;
wherein a combination of said ad/message slot ID and a content/asset ID creates said ad/message slot IDs for a particular content asset.

21. The method of claim 13, further comprising the step of:
centrally assigning an ID and managing an ID of any ad/message slot sales channel through said central access and monetization rights management database.

22. The method of claim 13, further comprising the step of:
assigning and managing IDs and permissions of any sales person or other system functionary within such an ad/message sales channel.

23. The method of claim 13, further comprising the step of:
assigning and managing access rights and monetization rights to any ad/message slot associated with any content asset.

24. The method of claim 13, further comprising the step of:
defining access right types comprising any of 100% access, proportional shared access, and access to a fixed number of ad/message slot per content asset per duration of time.

25. The method of claim 13, further comprising the step of:
defining and adding new access right types over time or modifying existing access right types;
wherein any particular access right type can only apply to a particular ad/message slot of any particular content asset.

26. The method of claim 13, further comprising the step of:
defining conditions under which granting of access rights occurs, said conditions comprising any of:
only when a relevant party originated a view or consumption of a content asset; and
creation of a sequential access order and allowing access only if there is no other existing ad/messages from any higher prioritized entities that have access rights.

27. The method of claim 13, further comprising the step of:
defining any particular ad/message slot, either in total or associated with any particular content asset or any grouping of content assets, as contingently accessible.

28. The method of claim 13, further comprising the step of:
defining conditions under which contingent access rights are granted, said conditions comprising any of:
minimum revenue potential per ad/message, geographic or time of day restrictions, or any other enabled method of identifying and targeting any ad/message slot.

29. The method of claim 13, further comprising the step of:
assigning actual access rights to any participating entity for any particular ad/message slot in, over, or around any particular content asset.

30. The method of claim 13, further comprising the step of:
assigning monetization rights and compensation rules to all enabled parties for any particular ad/message slot for any particular content asset.

31. The method of claim 13, further comprising the step of:
defining monetization right types and compensation rules comprising any of:
proportional advertising revenue share;
proportional advertising profit share;
fixed cost per instance of content consumption;
fixed cost for a fixed number of instances of content consumption; and
fixed cost for an unlimited number of instances of content consumption.

32. The method of claim 13, further comprising the step of:
defining and adding new monetization right types over time, or modifying existing monetization right types;
wherein any particular monetization right type can only apply to a particular ad/message slot of any particular content asset.

33. The method of claim 13, further comprising the step of:
transmitting the fact that a view has been initiated for a particular content asset, and an identity of that aggregator/distributor or other view originator of that content asset, to said asset and monetization rights management database upon each origination of a view or instance of consumption of any particular content asset.

34. The method of claim 13, further comprising the step of:
allocating actual access to any particular ad/message slot in any particular content asset based on rules in said asset and monetization rights management database.

35. The method of claim 13, further comprising the step of:
recording and storing actual effects and results of displaying or delivering a content asset and related ad/messages.

36. The method of claim 13, further comprising the step of:
calculating and accounting for compensation due to all relevant parties based on monetization rights as recorded in said asset and monetization rights management database.

37. The method of claim 13, further comprising the step of:
calculating and yield optimizing which business entity wins access rights for any ad/message slot that has contingent access rights.

38. The method of claim 13, further comprising the step of:
tracking, logging, and reporting on metrics and results comprising any of the following:
content asset usage by asset-view path of which business entity originated a view, by any entity that owns any form of access or monetization rights, and by any taxonomy or organization enabled in said content asset management database;
content value and revenue generation accounting and reporting by asset-view path of which business entity originated a view, by any entity that owns any form of access or monetization rights, and by any taxonomy or organization enabled in said content asset management database; and
permissions, rights management, and contracts.

39. The method of claim 13, further comprising the step of:
defining and managing ad/message slot virtual networks of any participating business entity that has potential access rights comprising any of:
content asset library management and related ad/message slot management; and
taxonomy and various grouping and organizational management of content assets and ad/message slots as desired to package for media sales comprising any of:
ad/message slot media buy sales process and order management;
ad/message best candidate message selection;
yield optimization; and
ad/message slot message serving and reporting.
